(19) United States
(12) Patent Application Publication
(10) Pub. No.: US 2012/0004906 A1
(43) Pub. Date: Jan. 5, 2012

(54) METHOD FOR SEPARATING SIGNAL PATHS AND USE FOR IMPROVING SPEECH USING ELECTRIC LARYNX

(76) Inventors: Martin Hagmuller, Graz (AT); Gernot Kubin, Graz (AT)

(21) Appl. No.: 13/147,893

(22) PCT Filed: Feb. 1, 2010
(86) PCT No.: PCT/AT10/00032

§ 371 Date: Sep. 19, 2011

(30) Foreign Application Priority Data
Feb. 4, 2009 (AT) A 193/2009

(51) Int. Cl. G10L 21/02

(52) U.S. Cl. 704/205; 704/E21.003

(57) ABSTRACT

In order to improve the speech quality of an electric larynx (EL) speaker, the speech signal of which is digitized by suitable means, the following steps are carried out: a) dividing a single-channel speech signal into a series of frequency channels by transferring it from a time domain into a discrete frequence domain; b) filtering out the modulation frequency of the EL by way of a high-pass or notch filter, in each frequency channel; and c) back-transforming the filtered speech signal from the frequency domain into the time domain and combining it into a single-channel output signal.

The present invention relates to a method for improving the speech quality of an electric larynx (EL) speaker, in which the speech signal of the speaker is digitised by suitable means. Suitable means are understood here to mean for example a microphone with associated analog/digital converter, a telephone or other methods using electronic equipment.

An EL is a device for forming an artificial replacement voice, for example for patients whose larynx has been surgically removed. The EL is applied to the lower side of the jaw; an audio-frequency signal generator having a specific frequency causes the air in the oral cavity to vibrate over the soft parts on the lower side of the jaw. These vibrations are then modulated by the articulation organs, so that speaking becomes possible. Since however the audio-frequency signal generator generally only operates at one frequency, the voice sounds monotonous and unnatural, like a “robot voice”.

A further disadvantage is that the vibration of the EL interferes with or even drowns out the perception of the speech, since only part of the sound is articulated in the oral cavity. The parts of the sound coming directly from the device or at the transition site on the neck are superimposed on the articulated part and reduce their comprehensibility. This is particularly the case with speakers who have undergone radiation therapy in the neck region, as a result of which the tissue structure becomes hard. Various methods have therefore been developed that aim to amplify the useful signal—i.e. the articulated vibrations—as opposed to the interfering signal—i.e. the direct sound, and the unmodulated vibration of the EL.

These methods are therefore predominantly used in situations in which the listener is not directly exposed to the emitted sound but instead electronic means are used, for example when telephoning, in sound recordings or generally when speaking via a microphone and amplifier.

In U.S. Pat. No. 6,359,988 B1 an EL voice signal is subjected to a cepstrum analysis and the speech of a normal speaker is superimposed, whereby the pitch variation of the person speaking with an EL can be made to sound more natural; at the same time the proportion of the emitted direct sound is thereby also suppressed at the signal. The disadvantage of this solution is particularly the fact that for each statement of an EL speaker the same statement of a healthy speaker (i.e. speaking without an EL) is synchronously required, which in practice is hardly realisable.

A further solution is illustrated in U.S. Pat. No. 6,975,984 B2, which describes a solution for improving an EL speech signal in telephony. In this case the speech signal is processed in a digital signal processor so that the humming basic noise of the EL is recognised and is removed from the speech signal. The speech signal is for this purpose divided into a voiced component and an unvoiced component and processed separately. The voiced part is Fourier-transformed blockwise, frequency filtered (basic frequency and harmonics are reused), back transformed and then subtracted from the overall original signal. What remains is the unvoiced component of the original signal. Alternatively it is also proposed to filter the voiced component through a low-pass filter, filter it out completely when a speech pause is recognised, and afterwards superimpose the unvoiced part.

The document “Enhancement of Electrolaryngeal Speech by Adaptive Filtering” by Carol Y. Espy-Wilson et al. (JSLHR, 41: 1253-1264, 1998) describes a method for improving the speech quality of an EL speaker. The basic noise of the EL is in this case adapted by means of adaptive filtering to the speech signal distorted by the EL basic noise (and the EL basic noise articulated to speech); in a further step the signals are subtracted from one another. What remains is an error signal that is used to check and adapt the filter parameters with the aim of minimising the error signal. The error signal in the present method is the speech signal freed from the EL basic noise. The assumption here is that although the interfering signal in the speech signal is correlated to the EL basic noise, the interesting speech signal is however independent of the other signals, so that virtually the interfering basic noise and the speech signal come from different sources.

The document “Enhancement of Electrolarynx Speech Based on Auditory Masking” by Hanjun Liu et al. (IEEE Transactions on Biomedical Engineering, 53 (5): 865-874, 2006) describes a subtraction algorithm for improving the signal of an EL speaker, especially in relation to ambient noise.

In contrast to other methods that involve fixed subtraction parameters, in this algorithm the subtraction parameters are adapted in the frequency range, based on auditory masking. In this connection it is assumed that speech and background noises are uncorrelated and therefore the background noise can be assessed and subtracted in the frequency range from the signal.

A common feature of these solutions is that methods are used based on a model in which speech and interfering signal (i.e. not only ambient noises but also the basic noise of the EL) are statistically independent and uncorrelated.

On account of this assumption the implementation of the aforementioned methods takes place in a very complex way. If an attempt is made to suppress the direct sound with an (adaptive) notch filter then the quality of the speech signal is thereby also reduced, which then sounds like whispering; the speech signal and interfering noise lie on the same harmonics.

US 2005/0004604 A1 describes a larynx solution, in which a sound generator and a microphone are placed directly in front of the mouth of a user, wherein the sound generator emits a sound with a low loudness level and the signal is picked up through the microphone for further processing. In the further processing the signal is basically filtered with a comb filter in order to reduce and/or remove the harmonics of the signal. In this case however the quality of the speech signal is seriously impaired.

In WO 2006/099670 A1 a device for monitoring the respiratory pathways is described, in which sound in the audible frequency range is introduced into the respiratory pathways of a subject and the state of the respiratory pathways is determined from the reflected and processed sound. It is thus possible for example to detect an obstruction of the respiratory pathways. In a variant of the invention it is checked by means of FFT (Fast-Fourier Transformation) whether certain threshold values are exceeded, from which conclusions can be drawn about the treatment of the measured signal.

An object of the invention is to overcome the aforementioned disadvantages of the prior art and to improve the speech quality of EL users when using electronic devices such as for example microphones.

This object is achieved according to the invention by a method of the type mentioned in the introduction, involving the following steps:

a) dividing a single-channel speech signal into a series of frequency channels by transferring it from a time domain into a discrete frequency domain,

b) filtering out the modulation frequency of the EL by means of a high-pass or notch filter in each frequency channel, and

c) back-transforming the filtered speech signal from the frequency domain into the time domain and combining it into a single-channel output signal.

The invention utilises an improved model of the use of an EL, according to which the EL basic noise articulated to a speech signal as well as the unaltered parts of the EL that interfere in the perception of the speech signal come from a common source, namely the EL. Since the interfering unarticulated basic noise of the EL in the modulation range is recognisable as a time-invariant signal, it can easily be filtered out by a suitable procedure. This therefore involves a separation not from signal sources, but from propagation paths (a propagation path through the organs of articulation of a speaker, a further propagation path from the site of use at the speaker's neck directly to the listener's ear, or to the microphone or recording means).

The person skilled in the art is acquainted with a large number of possible ways of converting a digitised, single-channel signal into the frequency domain and thus dividing it into a series of frequency channels. In each frequency channel the modulation frequency of the EL is suppressed by suitable filters—e.g. notch or high-pass filters, applied to the value—and the quality of the articulated signal parts is thereby improved.

Similar methods from the prior art regard the articulated parts as well as the unchanged parts as coming from different sources and choose approaches corresponding to this model, for example filtering by means of band-pass filters, which then however also attenuate the speech signal.

The method according to the invention is therefore aimed at improving the comprehensibility of the speech of EL users and making the signal more acceptable and “human”. The aim is to reduce and eliminate the direct sound from the EL when communicating via electronic means (e.g. telephone).

The realisation of the method according to the invention can be accomplished for example by a software plugin, as a fixed wired solution, or also as an analog circuit.

Of the large number of known methods for converting a signal to the frequency domain and back, the conversion in step a) of the method according to the invention is advantageously performed by means of a Fourier transformation and the back-transformation in step c) is advantageously carried out by means of an inverse Fourier transformation. The conversion is performed blockwise (e.g. blocks of 20 msec) at short intervals (refreshing for example every 10 msec). The division of the signal into a series of frequency channels takes place on converting the signal to the frequency domain.

In a variant of the invention the conversion of the speech signal in step a) and the back-transformation in step c) is carried out with a corresponding filter bank.

The results of the method according to the invention can be improved further if, before the filtering in step b), a signal compression is carried out and after step b) a decompression is carried out. Due to the compression, at high amplitudes changes of the latter can be prevented from becoming dominant to such an extent that the changes of small amplitudes are not taken into account. Due to the compression relative changes thus becomes more visible for the filter.

In a further implementation of the method according to the invention a rectification of the negative signal components is carried out before the back-transformation in step c).

The invention is described in more detail hereinafter with the aid of a non-limiting embodiment, which is illustrated in the drawings and in which:

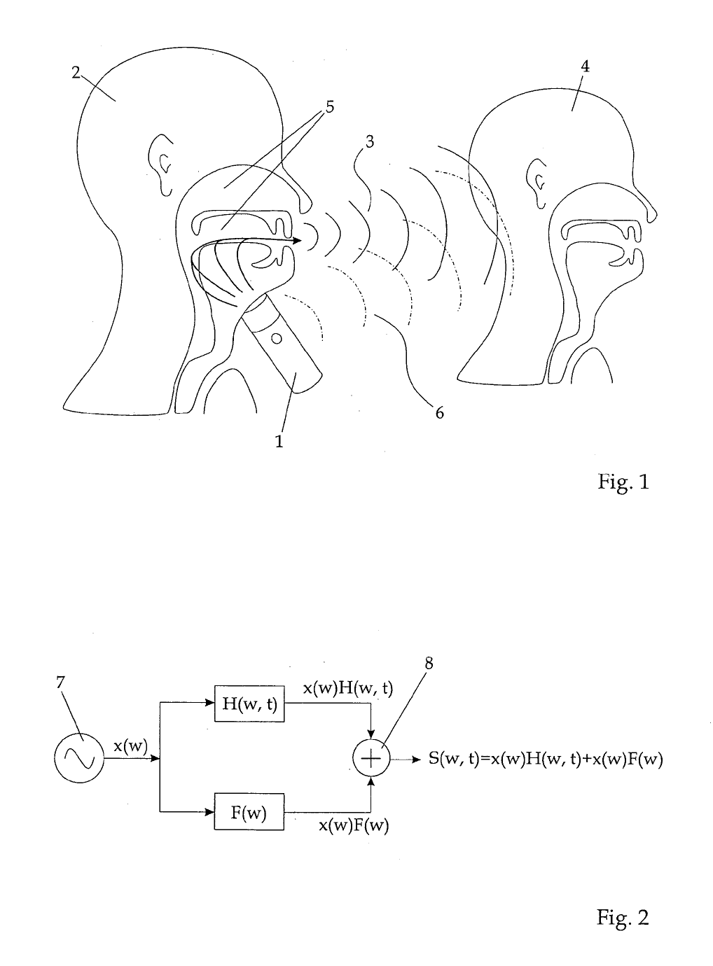

FIG. 1 shows schematically a simplified representation of the use of an EL and the occurring signal paths,

FIG. 2 shows schematically a simplified representation of the situation in which the method according to the invention is used, and

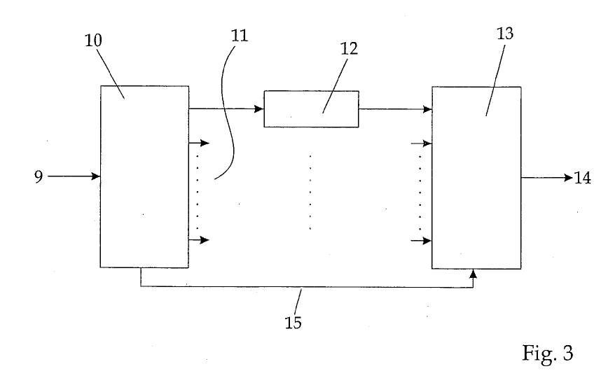

FIG. 3 shows schematically a functional block diagram of the method according to the invention.

The various transmission pathways of the signal of an EL 1 are illustrated in FIG. 1. An EL 1 is arranged on the neck of a speaker 2. The sound generated by the EL 1 is propagated on the one hand through the normal speech channels (mouth and nose) 5 of the first speaker 2 and is articulated there into speech; this first signal 3 is significantly variable and is time-variant. In addition to this time-variant signal 3, the listener's ear 4 also receives a second signal 6 (shown in chain-dotted lines in FIG. 1) in the form of the direct sound of the EL 1, this signal 4 being largely stationary and therefore assumed as time-invariant. The second part 6 of the overall signal, i.e. the basic noise of the EL 1, is recognised by the listener 4 as an interfering signal and reduces the comprehensibility of the speech of the speaker 2. The original excitation by means of the EL 1 is thus transmitted via two different paths.

Of course, the invention relates to the improvement of the speech quality of an EL speaker when using electronic devices—instead of by a listener the signals would therefore be received by a microphone for example. In order to illustrate the initial situation this general model was however chosen for reasons of comprehension.

FIG. 2 shows a simplified representation of the situation in which the method according to the invention is employed to suppress an interfering second signal 6 (see FIG. 1). It can readily be recognised that the method according to the invention does not involve a separation of signal sources, but of propagation paths.

A source signal x(w) from a signal source 7 is propagated via two different signal paths. In the first signal path the output signal is modulated by a time-variant filter H(w, t) to form a time-variant signal x(w)H(w, t). In the second signal path the output signal is altered only by a time-invariant filter F(w) to a signal x(w)F(w).

The signals of the two paths are then summated in a receiver 8—for example the ear of a listener, a microphone or the like—into a signal S(w, t) available for measurement. The signal thus consists of the sum of the components

S(w, t)=x(w)H(w, t)+x(w)F(w)

The signal parts from the time-invariant and the time-variant signal paths can now be separated, in which either all signal parts that vary over time or that are time constant, are damped. Therefore for example only the time-variant part S1(w, t)˜x(w)H(w, t) is obtained as the result.

When used for speech with EL the unarticulated signal part x(w)F(w) (i.e. the basic noise of the EL) is superimposed on the time-variant speech signal x(w)H(w, t) and thus producea a loss of comprehension for the speech signal. The speech comprehension is improved by separating the time-variant signal part from the time-invariant signal part.

FIG. 3 shows a possible conversion of the method according to the invention. In this, an arbitrary digital speech signal 9 from a speaker with EL can be present at the input. In a first step 10 the speech signal 9 is transformed blockwise into the frequency domain using the short-time Fourier transformation and is thus divided into a series of frequency channels. The person skilled in the art can choose here from various established methods for transforming a signal from the time domain into the frequency domain; apart from the Fourier transformation the discrete cosine transformation for example is also used—the precondition for a use according to the invention however is that the transformation is reversible. The signal is divided at a specific refreshing rate (e.g. 10 msec) into blocks of for example 20 msec length, which are in each case spread out into a series of frequency channels 11. The originally single-channel speech signal 9 is thus split into a plurality of frequency domains that alter over time. The frequency signal is complex, but in its further course only the absolute value is modified however, the phase 15 remaining unchanged.

In step 10 a filter bank can also be used, in which the sampling rate of the signal is reduced after the filter bank. The reduction of the sampling rate corresponds in this connection to the block formation when using the Fourier transformation.

Each frequency channel 11 is now filtered in a further function block 12, for example with a high-pass or notch filter. This filtering enables certain frequencies to be filtered out—in sound technology narrow-band interferences are filtered out with notch filters. Since the EL oscillates at a certain frequency—for example 100 Hz—the interfering signal, which is not altered by the articulation organs of a speaker, produces in the frequency range amplitudes in the 100 Hz channel with the modulation frequency 0 Hz—i.e., the amplitude of the EL signal does not alter. The interfering signal is characterised by the fact that it is perfectly time-invariant. A notch or'a high-pass filter is used to filter the basic noise of the EL. In this connection the modulation frequency of the EL serves as a limiting frequency for the high-pass filter; the notch filter is therefore chosen so that it locks exactly at the modulation frequency of the EL.

Of course, in a real implementation a perfect time invariance will not be achievable on account of reflections, refractions, ambient noise and structural demands of the EL. Since however the filter is also not restricted to only one frequency, but covers a specific frequency range—in this case a modulation frequency range—the function of the method according to the invention is ensured.

In a final function block 13 the signals are converted back into the time domain, for example by means of an inverse Fourier transformation, and the frequency channels 11 are recombined into one channel by means of overlap-add. The overlap-add method is a method known to the person skilled in the art from digital signal processing. The result is a single-channel output signal 14, in which the interfering signal of the EL is filtered out or at least damped. The output signal can then be processed further.

When using a filter bank in step 10 the sampling rate of the signal after the filtering in step 12 is increased again and is then processed further as outlined hereinbefore.

In principle these procedures represent only the most important parts of the method according to the invention; before the filtering in block 12 the signal can be compressed, and after the filtering a decompression can be carried out. Also, a rectification may be advantageous before the back-transformation into the time domain, since unallowed negative values may occur in the processing.

The invention can for example be used as an additional device in telephoning. With a conventional analog telephone the device is simply integrated into the earphone. With a telephone provided with an integrated digital signal processor the invention can be integrated using a software plugin. It is also possible to realise the invention within the scope of a fixed wired solution, for example also in an analog circuit.

The method according to the invention can also be employed when using an EL, in which switching backwards and forwards between two or more frequencies can be carried out in order to give the speech a more realistic sound. This applies both to discrete frequency jumps as well as to continuous changes of the basic frequency, assuming that the frequency switches lie within a frequency band into which the basic signal is divided.

The width of the modulation frequency filter then determines how quickly the frequency is allowed to change. With very slow, continuous changes the frequency can with a functioning suppression change over the whole range of the frequency band—the decisive factor is not the size but the speed of the change. When switching the EL on and off, which corresponds to a rapid change, the suppression kicks in after only a few milliseconds, depending on how wide the notch filter is or where the basic frequency of the high-pass filter lies.

In this connection the changes in the basic frequency must not be too large however. In order for the function according to the invention to be reliable, the frequency channels into which the signal is divided would for example have to be widened, or the filtering by means of a high-pass filter would have to be set at a somewhat higher frequency.

1. A method for improving the speech quality of an electric larynx (EL) speaker, whose speech signal is digitised by suitable means, comprising the following steps:
a) dividing a single-channel speech signal into a series of frequency channels by transferring it from a time domain into a discrete frequency domain,
b) filtering out the modulation frequency of the EL by means of a high-pass or notch filter in each frequency channel, and
c) back-transforming the filtered speech signal from the frequency domain into the time domain and combining it into a single-channel output signal.

2. The method according to claim 1, wherein the conversion of the speech signal in step a) is carried out by means of a Fourier transformation and the back-transformation in step c) is carried out by means of an inverse Fourier transformation.

3. The method according to claim 1, wherein the conversion of the speech signal in step a) and the synthesis of the frequency channels in step c) is carried out with a filter bank.

4. The method according to claim 1, wherein before the filtering in step b) a signal compression is carried out, and after step b) a decompression is carried out.

5. The method according to claim 1, wherein before the back-transformation in step c) a rectification of the negative signal components is carried out.
